(19) United States
(12) Patent Application Publication
(10) Pub. No.: US 2022/0270152 A1
(43) Pub. Date: Aug. 25, 2022

(54) ITEM CONTRASTING SYSTEM FOR MAKING ENHANCED COMPARISONS

(71) Applicant: Adobe Inc., San Jose, CA (US)

(72) Inventors: Georgios Theocharous, San Jose, CA (US); Nedim Lipka, Campbell, CA (US); Michele Saad, Austin, TX (US)

(73) Assignee: Adobe Inc., San Jose, CA (US)

(21) Appl. No.: 17/180,693

(22) Filed: Feb. 19, 2021

(51) Int. Cl. G06Q 30/06; G06F 40/205; G06F 40/284

(52) U.S. Cl. CPC G06Q 30/0629; G06Q 30/0643; G06Q 30/0631; G06Q 30/0603; G06F 40/205; G06F 40/284

(57) ABSTRACT

Techniques are provided herein for identifying contrasting items based on a target item and presenting each of the target item and contrasting items together to a user. The target item may be any item that is of interest to the user. The contrasting items are identified using a system that compares features of the items together and also considers historical user data associated with the items. Natural language processes are used to label and identify salient portions of the catalog data for the items. Historical user data between items may be determined based on one or more documented event actions that occur with regards to co-viewing the items in some fashion. Both the historical user data and catalog comparisons between items are combined to determine a similarity score or metric between items. Items having highest similarity scores with the target item within a same cluster or group are presented.

### FIELD OF THE DISCLOSURE

This disclosure relates to techniques for combining tracked online user activity with catalogued item data to determine meaningful contrasts between a target item and selected other items that enhance the desirability of a target item when that target item is compared to the selected other items.

### BACKGROUND

Making determinations regarding similarities or differences between various items can be useful for a variety of applications, including online portrayal of items for sale via an online selling platform. For instance, such platforms often present other items that are similar to a target item being viewed by a user in an attempt to provide the user more choices when trying to make a purchasing decision. However, the mechanisms that determine what other items should be shown to a user are not intelligent. In more detail, such mechanisms either involve: (1) allowing the user to select items they would like to compare and then displaying the user-selected items next to each other for easier viewing and comparison; or (2) automatically showing a predetermined and fixed set of related catalog items that share certain similarities to a target item the user is currently viewing thereby allowing the user to make a sort of comparison. As will be appreciated in light of this disclosure, the problem with such techniques is that they are “dumb” in the sense that they do not purposefully select contrasting items to enhance or influence a shopper's decision-making regarding a target item. For instance, such techniques fail to identify and highlight the displayed items' salient features/attributes that influence the shopper's preference to make a purchase and that influence the price variability within the contrasting group of items. Therefore, complex and non-trivial issues associated with comparing and contrasting online items remain, in the context of online shopping.

### SUMMARY

Techniques are provided herein for identifying contrasting items based on a target item and presenting each of the target item and contrasting items together to a user. The target item may be, for instance, an item predicted to be the shopper's first choice, but in a more general sense can be any item of interest to the user (such as an item that has been selected and is being viewed by the user, or an item that a user added to a shopping cart). In any case, the contrasting items are purposefully selected to enhance the desirability of the target product, such that the user is more likely to purchase the target product after viewing it along with the selected contrasting items. The contrasting items are selected based on online user activity data and cataloged item feature data. In some examples, for instance, the online user activity data includes co-occurrence data with respect to contemporaneously viewed items, and the cataloged item feature data includes feature data indicated in text fields of the catalogue in which a given item is listed. In more detail, online user activity data is collected and compared to determine how often items co-occur with one another (viewed together online in a contemporaneous fashion). A webserver or other networked computer that tracks or otherwise has access to the online user activity data of a given web site can be used to collect the online user activity data and determine co-occurrence between items. Additionally, the webserver or other networked computer identifies cataloged item features (as specified in catalogue text fields descriptive of the cataloged item features) using one or more natural language processing (NLP) techniques and compares the features to one another to determine quantitative feature similarity between items. Example NLP and comparison techniques are provided herein. A geometric mean of both the co-occurrence data and the feature similarity data generates similarity values between items, which can be arranged in an item matrix to quickly group and identify items together based on their similarity values. So, for example, a given similarity value between a first item and second item is provided in the matrix at the intersection between the row corresponding to the first item and the column corresponding to the second item. The matrix of item similarity values can then be readily used to select meaningful contrasting items with a target item. As will be further appreciated, the selection is more complex than merely selecting items that have a highest similarity value with the target item. Rather, items are selected that have both high similarity values, and have close similarity values to each other. Furthermore, in accordance with some such embodiments, two contrasting items are chosen such that one of the contrasting items is more expensive than the target item while the other contrasting item is less expensive than the target item. In any case, the web server or other networked computer can then cause display of the target item along with the selected contrasting items simultaneously for a user to view. Accordingly, both online user activity data and cataloged item feature data is combined to intelligently select contrasting items that enhance the desirability of a target item based on the compromise effect.

As noted above, the techniques described herein are useful in a number of different settings and contexts, but they are especially useful for e-commerce (e.g., online selling platforms). Nearly every large retailer has a presence in the e-commerce realm and sells their items through a website or other online application. According to some embodiments, the item contrasting techniques described herein can be used to help enhance the desirability of any given item for any e-commerce platform by intelligently selecting contrasting items that specifically make the given item look better in comparison.

As previously explained, the target item may be any item that is of interest to the user, and the contrasting items can be items in the same category as the target item but each having one or more different features than the target item. For example, the target item can be a product currently being viewed by a user on a website, and the contrasting items can be other products in the same category as the target product but each having one or more different features (e.g., the target item can be a specific ring, and the contrasting items can be other rings configured differently than the specific ring). In an embodiment, the contrasting items are identified using a system that compares features of the items together and also tracks online user activity data associated with the items. The online activity between any two given items refers to user action taken with respect to those items, such as co-viewing the two items during a same online session. Such action is referred to herein as an event action. The number of times a given pair of items are co-viewed can be weighted against the number of co-views for a pair of items with the highest number of co-view actions to determine a co-occurrence score for the given pair of items. The item feature analysis is multimodal in that it leverages numerous diverse techniques that mine catalog data corresponding to the items within that catalogue to determine a level of similarity between the items. These techniques include, for example, natural language processing techniques to identify salient portions of the catalog data for the items. Example natural language processing techniques include, for instance, vectorizing, one hot encoding, TFIDF (term frequency inverse document frequency) weighting, parsing, stop word removal, speech tagging, sparse data processing, or dense data processing. The techniques further include comparison techniques that may include, for example, any one or more of dot product determination, cosine similarity analysis, L2 analysis, or Hamming distance determination. A product of the outputs from various comparison techniques for different catalog text fields between a given pair of items provides a relevance score for the given pair of items. A geometric mean is determined between the co-occurrence score and the relevancy score of the given pair of items to provide a similarity score for the given pair of items. Items can then be clustered or otherwise grouped based on their similarity scores with one another. Given this arrangement, items having high similarity scores with the target item, and similarity scores that are close to one another, within the same cluster or group are identified and presented to the user, thus providing the user with highly relevant contrasted items along with a target item. Numerous variations and embodiments will be appreciated in light of this disclosure.

Any number of non-transitory machine-readable mediums (e.g., embedded memory, on-chip memory, read only memory, random access memory, solid state drives, and any other physical storage mediums) can be used to encode instructions that, when executed by one or more processors, cause an embodiment of the techniques provided herein to be carried out, thereby allowing for the identification of contrasting items to provide to a user. Likewise, the techniques can be implemented in hardware (e.g., logic circuits such as field programmable gate array, purpose-built semiconductor, microcontroller with a number of input/output ports and embedded routines). Numerous embodiments will be apparent in light of this disclosure.

### BRIEF DESCRIPTION OF THE DRAWINGS

FIGS. 1A-1C show example user interfaces of an item contrast system configured to identify contrasting items to provide to the user, in accordance with an embodiment of the present disclosure.

FIG. 2 shows an example system having an item contrast system, configured in accordance with an embodiment of the present disclosure.

FIG. 3 is a flow diagram of an item contrasting process, configured in accordance with an embodiment of the present disclosure.

FIG. 4 is a flow diagram of a sub-process of the item contrasting process of FIG. 3, for identifying user-based event actions between items, in accordance with an embodiment of the present disclosure.

FIG. 5 is a flow diagram of a sub-process of the item contrasting process of FIG. 3, for identifying a level of relevance between items based on category features of the items, in accordance with an embodiment of the present disclosure.

FIG. 6 is a flow diagram of a sub-process of the item contrasting process of FIG. 3, for determining similarity scores between items and clustering items based on their similarity scores, in accordance with an embodiment of the present disclosure.

FIG. 7A illustrates an example similarity matrix and FIG. 7B illustrates an example of a clustered version of the similarity matrix, in accordance with an embodiment of the present disclosure.

FIG. 8 is a flow diagram of a sub-process of the item contrasting process of FIG. 3, for identifying the most relevant contrasting items to present to a user along with a target item, in accordance with an embodiment of the present disclosure.

### DETAILED DESCRIPTION

Techniques are provided herein for identifying contrasting items based on a target item and presenting each of the target item and contrasting items together to a user. The contrasting items may be chosen amongst multiple items that share some commonality with one another, like pieces of jewelry from an online jewelry store, or articles of clothing from an online department store. Accordingly, there may be many possible items to choose from when trying to determine similar items to compare and contrast with a target item. Prior techniques for displaying similar items to a user either involve the user manually selecting different items to be displayed in a side-by-side comparison, or automatically displaying a predetermined and fixed set of related catalog items that share certain similarities with a user-selected item. But all of these prior techniques fail to provide meaningful contrasting items that actually enhance the desirability of the target item for the user. As will be appreciated in light of this disclosure, the one-dimensional nature of existing comparison systems precludes them from determining which items are the best ones to present to a user as contrasting items that are purposefully selected to enhance the desirability of the target item.

In more detail, and according to some embodiments, a database of item similarity scores is generated amongst any number of different items, by an item contrast system within a webserver or other networked computer system. A similarity score provides a quantitative similarity measure between two items. Accordingly, each similarity score provides a similarity measure between two items of a plurality of different items. In some such embodiments, the item contrast system compares numerous features of the items together and also considers tracked online user activity associated with the items in order to determine the similarity scores between items. The item contrast system uses natural language processing to label and identify salient portions of catalog data associated with the items. Example salient portions of catalog data associated with the items include, for instance, item name, item description (including meta and short version if available), product category or categories to which the item belongs, item price, and list of item attributes. Example natural language processing techniques include vectorizing, one hot encoding, TFIDF weighting, parsing, stop word removal, speech tagging, sparse data processing, or dense data processing, to name a few examples. The item contrast system also uses comparison techniques such as dot product determination, cosine similarity analysis, L2 analysis, or Hamming distance determination to identify a degree of relevancy between items. The item contrast system uses documented event actions (as informed by tracked online user activity) that occur with regards to co-viewing the items in some fashion online to define a measure of co-occurrence between items. Both the co-occurrence scores and relevancy scores are combined (e.g., by determining the geometric mean of the scores) to determine similarity scores between the items, according to some embodiments. Numerous variations and embodiments will be appreciated in light of this disclosure.

In further detail, and according to an embodiment, the various items can be clustered or otherwise grouped based on their similarity scores in a matrix format with the list of items along the X and Y axes of the matrix for easier contrast analysis with other items from the same group. For example, each row or column of the matrix associated with a given item provides similarity scores between that given item and each other item. Spectral clustering methods may be used to identify item clusters in the similarity matrix. Example clustering methods for identifying an ideal number of clusters to include as many of the items as possible include the Calinski-Harabasz index function or an Eigengap heuristic. This clustered database of items can be generated at any time before a contrasting analysis is performed when a target item is viewed by a user. When a user does view a target item (e.g., viewing the item online), the item contrast system identifies at least two other items from the same group as the target item (e.g., in the same cluster as the target item and along the row or column associated with the target item) that have the highest and most similar similarity scores to the target item. This means that items with the highest similarity scores are not necessarily the ones chosen by the item contrast system to provide to the user. For example, if similarity scores are provided on a scale of 1-100, and item 1 has a similarity score to the target item of 95, item 2 has a similarity score to the target item of 76, and item 3 has a similarity score to the target item of 73, item contrast system would provide items 2 and 3 to the user as they are high and relatively closer to one another compared to item 1. The identified contrasting items can then be presented to the user alongside the target item. According to some embodiments, two contrasting items are selected such that one item is more expensive than the target item and the other item is less expensive than the target item. As will be appreciated, this selection routine injects a unique intelligence into determining items that are most likely to persuade the user to purchase the target item based on the compromise effect. Furthermore, the most distinguishing item features can be listed along with each of the provided items. According to some embodiments, the item contrast system determines the most distinguishing item features among items in a group using a regression analysis on the prices of the items in the group with the item features as inputs to the regression. In other words, item features that are found to have the highest influence on the price of the item are determined to be more distinguishing and thus chosen to display along with the items.

As will be appreciated, the present disclosure provides a technical solution to the technical problem facing other item selection techniques. Specifically, other item selection techniques merely query a user for manual selection, or only provide a fixed set of other items with similar characteristics to the target item without any consideration as to how those other items affect the desirability of the target item. However, the presently described item contrast system provides a technical solution to this problem by comparing text-based features of the items together and also by comparing tracked online user activity associated with the items to generate similarity scores between items. In an embodiment, the item contrast system uses natural language processing to label and identify salient portions of catalog data associated with the items and compares the text-based catalog data using techniques such as dot product determination, cosine similarity analysis, L2 analysis, or Hamming distance determination to identify a degree of relevancy between items. The item contrast system uses documented event actions (derived from the online user activity) that occur with regards to co-viewing the items in some fashion online in order to define a measure of co-occurrence between items. The system can then select two contrasting items with similar similarity scores to one another and on opposite sides of the price of the target item to provide intelligent contrasting items that enhance the desirability of the target item based on the compromise effect.

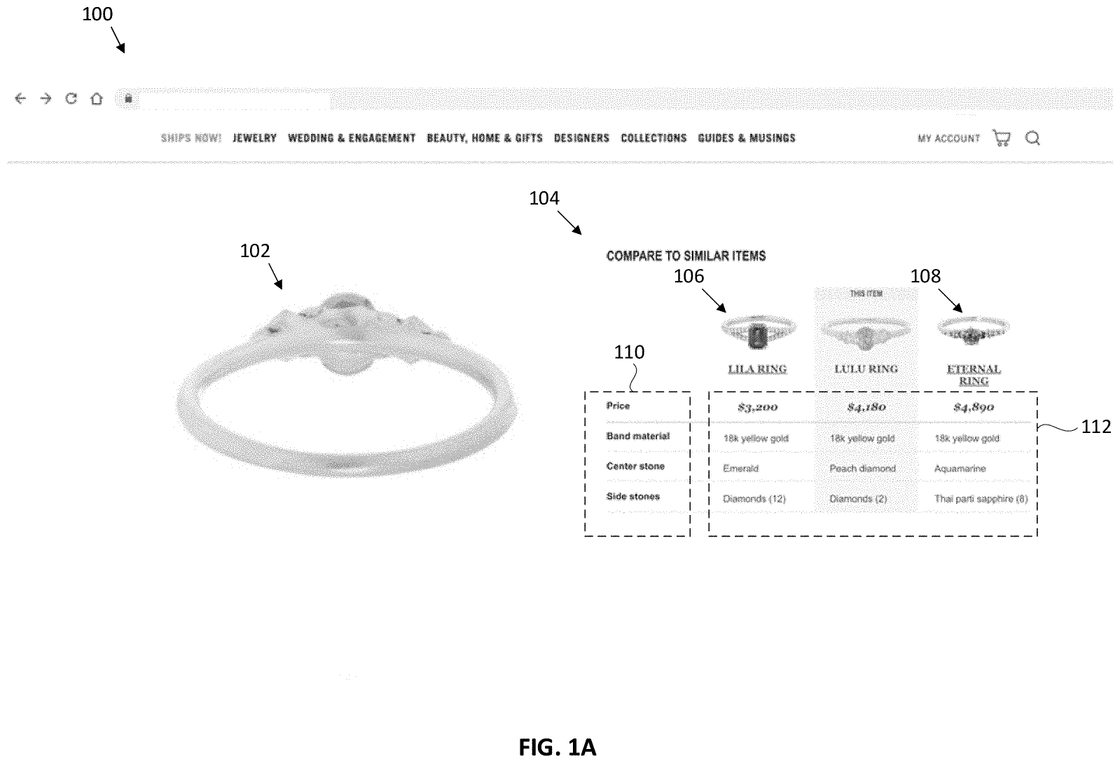

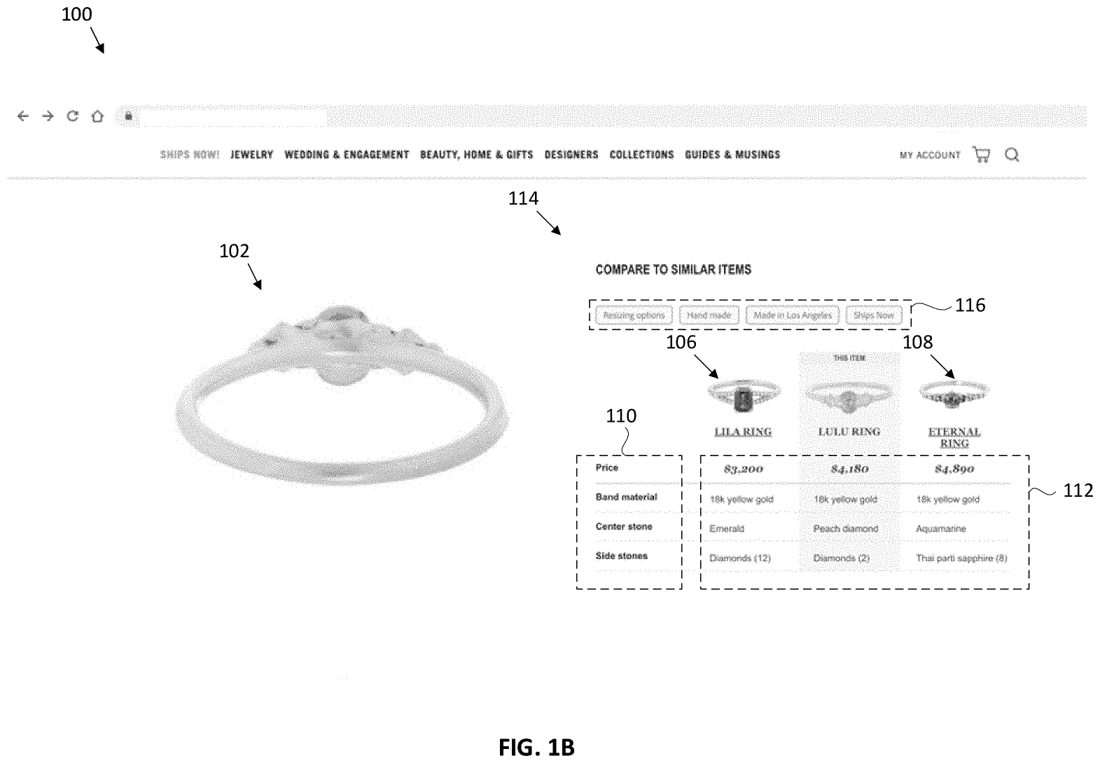

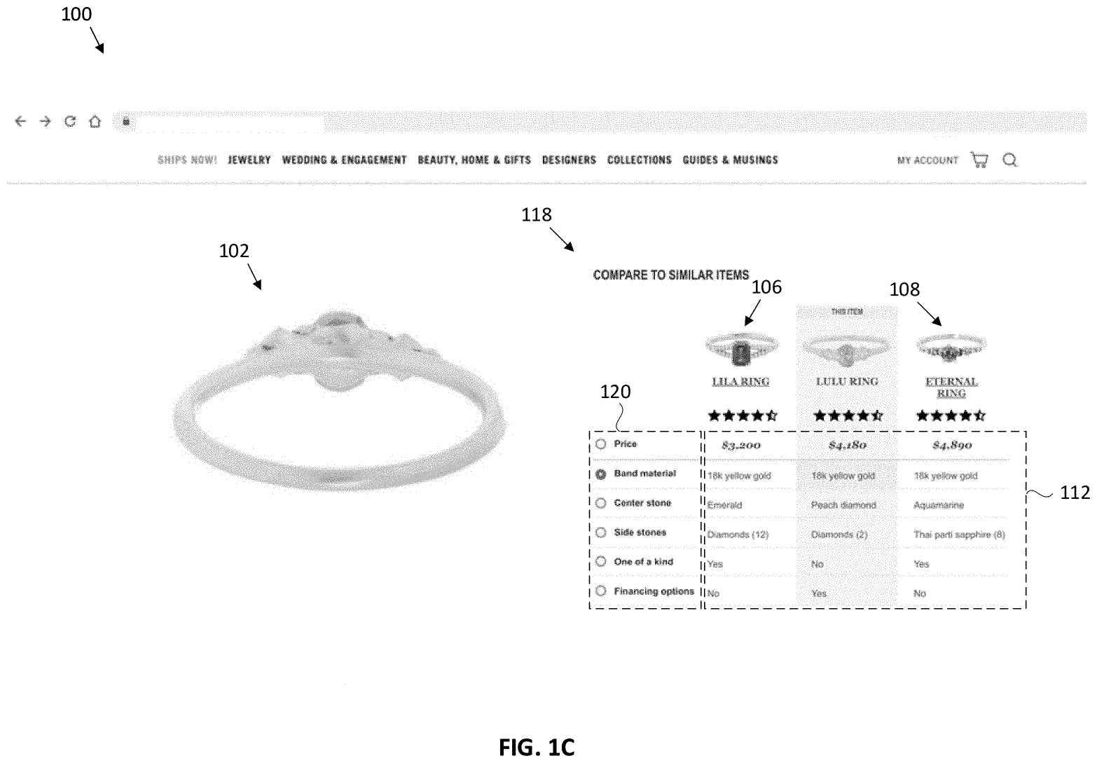

So, an item contrasting technique according to an embodiment provides meaningful contrasting items to compare with a target item of interest by using a multi-modal approach that leverages (1) cataloged item feature similarity between the items as well as (2) user online viewing history between the items. More specifically, online viewing history between various items is tracked and used to determine how often certain items are viewed together. These co-viewing actions provide a co-occurrence metric (or score) between items. Cataloged features of various items are compared using a variety of natural language processing techniques along with a variety of comparison techniques to provide relevance scores between items. Both the co-occurrence scores and the relevance scores are combined to create similarity scores between items. The items can be clustered in matrix based on their similarity scores, allowing for contrasting items to be found quickly on the same row or column as the target item in the matrix. The target item along with some selected contrasting items are then presented to the user (e.g., as illustrated in any of FIGS. 1A-1C).

### TERM DEFINITION

As used herein, the term “co-occurrence score” refers to a defined value between two items of a plurality of cataloged items, the defined value representing how often the two items are viewed together online compared to how often other items of the plurality of cataloged items are viewed together. Accordingly, the co-occurrence score can be a weighted value between 0 and 1.

As used herein, the term “event action” refers to any action performed by a user that involves an association being made between two items of a plurality of cataloged items. An event action may be, for example, co-viewing two items online. In one example, two items viewed online by a user one after the other or viewed within a short time of one another (e.g., within the same online session) can count as one instance of co-viewing between the two items. An event action is a “documented event action” when evidence of that action is available, such as standard user analytics data like click data, co-viewing (where two or more products are viewed online side-by-side or in an otherwise contemporaneous manner), and viewing times.

As used herein, the term “co-viewing” or “co-view” refers to the case where two or more products are viewed online side-by-side or in an otherwise contemporaneous manner such as the case where a first product is viewed and then second product is viewed right after the first product is viewed. In the latter case, a threshold of time between the first and second viewings can vary from one embodiment to the next, but in some example cases is in the range of 120 seconds or less between viewings, or at least viewed during the same online session.

As used herein, the term “item relevance score” refers to a defined value between two items of the plurality of cataloged items that represents a level of similarity between the items based on cataloged text fields associated with different aspects of the items. The item relevance scores may be an agglomeration of different comparison metrics associated with different text fields of the cataloged data. The item relevance score can be a weighted value between 0 and 1.

As used herein, the term “similarity score” refers to a defined value between two items of the plurality of cataloged items that represents a level of similarity between the items based on both the co-occurrence score and the relevance score between the two items. The similarity score can be a value between 0 and 1 that integrates both user-based data and feature similarity metrics.

As used herein, the term “similarity matrix” refers to a two-dimensional array of similarity scores between items with the total number of items listed along the X and Y axes of the 2D array. The similarity score between a first item along a row of the similarity matrix and a second item along a column of the similarity matrix is provided at the intersection of the row and the column.

### GENERAL OVERVIEW

In accordance with some embodiments, providing contrasting items that makes the user more likely to select the target item that they are being contrasted includes a solution that can intelligently use the available data regarding the items to select the best contrasting items that work to highlight the advantages of the target item. For example, if a user is viewing a necklace online (e.g., the target item) that they may be interested in, the item contrast system will access the database of clustered items based on similarity scores and select at least two other necklaces to contrast with the target necklace that make the target necklace look even more appealing. For example, the two contrasting necklaces may include one necklace that is less expensive but clearly has inferior features to the target necklace, and another necklace that has similar features to the target necklace but is more expensive. So, in this example use case, when the user views the target target necklace, the two contrasting necklaces are identified from the same cluster as the target necklace and have the highest and most similar similarity scores to the target item. This means that necklaces with the highest similarity scores are not necessarily the ones chosen to provide to the user. For example, if similarity scores are provided on a scale of 1-100, and necklace 1 has a similarity score to the target necklace of 95, necklace 2 has a similarity score to the target necklace of 76, and necklace 3 has a similarity score to the target necklace of 73, then necklaces 2 and 3 are provided as the two contrasting necklaces to the user as they (1) have relatively high similarity to the target necklace and (2) are relatively closer to one another. Note that necklace 1, which has the highest similarity score with respect to the target necklace, is not chosen as a contrasting necklace, because it is not sufficiently close in similarity to another contrasting necklace. The identified contrasting necklaces can then be presented to the user alongside the target necklace. Any type of item could be contrasted in a similar way.

The techniques may be embodied in devices, systems, methods, or machine-readable mediums, as will be appreciated. For example, according to one example embodiment of the present disclosure, a system is provided that is configured to identify contrasting items to a target item being viewed by a user. The system includes at least one processor and one or more modules executable by the processor(s) to carry out the process of identifying contrasting items to the target item to provide to the user. In one example embodiment, the one or more modules include a co-occurrence module, a relevance scoring module, a similarity module, and a contrast selection module. Other embodiments may have fewer or more functional modules; to this end, the degree of modular integration can vary from one embodiment to the next, but the overall desired functionality can still be achieved. The co-occurrence module generates a co-occurrence score between each item of a plurality of cataloged items against each other item of the plurality of cataloged items. The co-occurrence score between any two items is based on one or more documented event actions by one or more users with regards to co-viewing the two items. The relevance scoring module generates an item relevance score between each item of the plurality of cataloged items against each other item of the plurality of cataloged items. The item relevance score between any two items is based on comparisons between cataloged text fields associated with the two items. The text fields may be accessed from a stored catalog of item features. The similarity module generates similarity scores between each item of the plurality of cataloged items against each other item of the plurality of cataloged items by taking a geometric mean of a product of the co-occurrence scores and the item relevance scores between the items. The contrast selection module is designed to identify a first item having a first similarity score with the target item and a second item having a second similarity score with the target item, the first and second similarity scores being within a threshold of one another, and cause simultaneous display of the target item, the first item, and the second item.

According to another example embodiment of the present disclosure, a method is provided for identifying contrasting items to a target item being viewed by a user. The method includes: generating a co-occurrence score between each item of a plurality of cataloged items against each other item of the plurality of cataloged items, wherein the co-occurrence score between any two items is based on one or more documented event actions by one or more users with regards to co-viewing the two items; generating an item relevance score between each item of the plurality of cataloged items against each other item of the plurality of cataloged items, where the item relevance score between any two items is based on comparisons between text fields associated with the two items; generating similarity scores between each item of the plurality of cataloged items against each other item of the plurality of cataloged items by determining the geometric mean of a product of the co-occurrence scores and the item relevance scores between the items identifying a first item having a first similarity score with the target item and a second item having a second similarity score with the target item, the first and second similarity scores being within a threshold of one another; and causing simultaneous display of the target item, the first item, and the second item.

Numerous examples are described herein, and many others will be appreciated in light of this disclosure. For example, although many of the examples herein refer to using the disclosed techniques to provide contrasting items in the context of making an online purchase, the same techniques can be equally applied to other applications where providing item comparisons are useful.

### EXAMPLE USE SCENARIO

FIGS. 1A-1C each show a user interface of an item contrast system configured in according with an embodiment of the present disclosure. The user interface is in the form of an online browser window 100, which can be accessed or otherwise executed in the context of any browser application. As can be seen in these example use cases, each of FIGS. 1A-1C illustrates a view of an online website selling particular items, which is jewelry in this example. It should be understood that the views and specific details of the website can vary from one embodiment to the next. Other examples of laying out similar components with the same functionality would be readily apparent in light of this disclosure.

FIG. 1A illustrates a browser window 100 that shows an online website for browsing and purchasing certain items. Browser window 100 includes a view of a particular target item 102 that is being advertised or otherwise viewed by a user. Browser window 100 also includes a contrast section 104 that includes the target item provided alongside at least a first contrasting item 106 and a second contrasting item 108. In this example, the ring being viewed by the user (target item 102) is between two other rings that represent first contrasting item 106 and second contrasting item 108. According to some embodiments, each of first contrasting item 106 and second contrasting item 108 are selected, by the item contrast system, from among a plurality of other items due to having high similarity scores compared to the target item 102 and close similarity scores to one another (e.g., within a threshold percentage of one another). For example, if similarity scores are provided on a scale of 1-100, and a first ring has a similarity score to the target ring of 95, a second ring has a similarity score to the target ring of 76, and a third ring has a similarity score to the target ring of 73, then the second and third rings are provided as the two contrasting rings 106 and 108 to the user as they (1) have relatively high similarity to the target ring 102 and (2) are relatively closer to one another. Note that the first ring in this example use case, which has the highest similarity score with respect to the target ring 102, is not chosen as a contrasting ring, because it is not sufficiently close in similarity to another contrasting ring. In some embodiments, selection criteria for first contrasting item 106 requires that it is less expensive than target item 102 while selection criteria for second contrasting item 106 requires that it is more expensive than target item 102.

According to some embodiments, contrast section 104 also includes a list of item features 110 along with the corresponding item attributes 112 for each of the identified item features 110. As noted above, the listed item features 110 may be selected from among many possible item features. The item contrast system selects the most relevant item features to list based on a regression analysis of the prices of various items to determine which features have the greatest influence on the item price, according to an embodiment.

FIG. 1B illustrates browser window 100 showing target item 102 and a different contrast section 114, according to an embodiment. Contrast section 114 shares many similarities with contrast section 104, including the arrangement of the target item between first contrasting item 106 and second contrasting item 108. However, contrast section 114 also provides a feature selection region 116 that lists one or more additional features that can be added to feature list 110, according to an embodiment. Feature section region 116 may include clickable buttons labeled with a corresponding feature category. When one of the buttons is clicked or touched by a user, the corresponding feature category is added to feature list 110 and is removed from feature selection region 116. Once a feature category is added to feature list 110, the corresponding item attributes 112 for that feature category can be automatically filled in for each of target item 102, first contrasting item 106, and second contrasting item 108.

FIG. 1C illustrates browser window 100 showing target item 102 and a different contrast section 118, according to an embodiment. Contrast section 118 shares many similarities with contrast section 104, including the arrangement of the target item between first contrasting item 106 and second contrasting item 108. However, contrast region 118 includes a selectable feature list 120. By selecting one of the features in selectable feature list 120, each of first contrasting item 106 and second contrasting item 108 must have the same selected feature as target item 102. A user may select one or more of the features of selectable feature list 120 using any means, such as clicking on an empty field adjacent to the names of the features or clicking on the names of the features themselves. In the illustrated example, the feature “band material” has been selected in selectable feature list 120. Accordingly, both first contrasting item 106 and second contrasting item 108 are chosen by the item contrast system to have the same band material as target item 102, which in this example is 18 k yellow gold. If, for example, the user also or alternatively selected “center stone”, then the item contrast system would select new items for both first contrasting item 106 and second contrasting item 108 that shared the same center stone as target item 102, which in his example is a peach diamond. When selecting new items for first contrasting item 106 and second contrasting item 108 that match selected features, the item contrast system still attempts to identify items that also have high similarity scores with target item 102, and close similarity scores to one another. In some embodiments, the newly selected items are also chosen such that first contrasting item 106 is less expensive than target item 102, and second contrasting item 108 is more expensive than target item 102.

### SYSTEM ARCHITECTURE

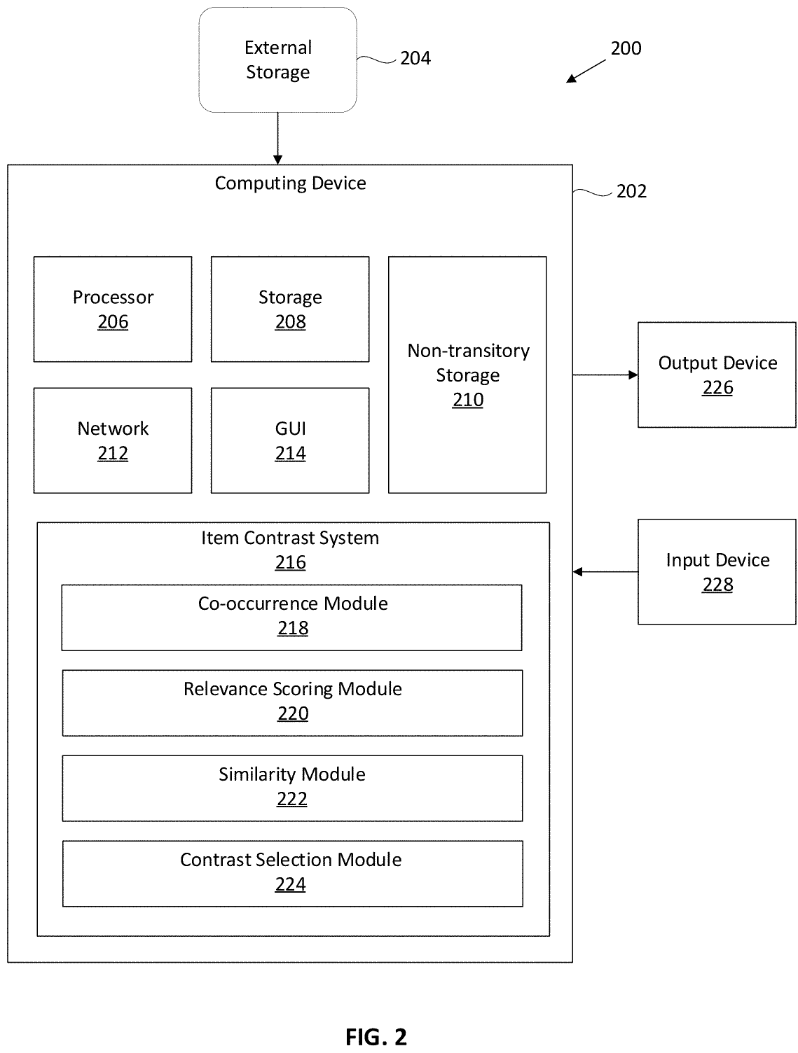

FIG. 2 shows an example system 200 that, among other things, implements an item contrast system 216 to identify contrasting items to provide to a user, according to an embodiment. The system 200 includes various hardware components such as a computing device 202 having a processor 206, a storage 208, a non-transitory storage medium 210, a network interface 212, and a graphical user interface (GUI) 214. As will be appreciated, item contrast system 216 may be part of a more comprehensive web application. GUI 214 may include a display and a user input device. In some embodiments, GUI 214 represents a command-line interface. In some embodiments, computing device 202 represents a web server or any other type of networked computing system that analyzes similarities between items and organizes the items accordingly, such that identified contrasting items can be shared with a user. In this way, computing device 202 communicates with other networked computing devices to receive input (e.g., a target item being viewed by a user) from such devices and provide output (contrasting items with the target item) to such devices.

According to some embodiments, processor 206 of the computing device 202 is configured to execute the following modules of item contrast system 216, each of which is described in further detail below: co-occurrence module 218, relevance scoring module 220, similarity module 222, and contrast selection module 224. In some embodiments, computing device 202 is configured to store an item database, including a catalog of features associated with each item, in external storage 204 or in storage 208. External storage 204 may be local to device 202 (e.g., plug-and-play hard drive) or remote to device 202 (e.g., cloud-based storage), and may represent, for instance, a stand-alone external hard-drive, external FLASH drive or any other type of FLASH memory, a networked hard-drive, a server, or networked attached storage (NAS), to name a few examples. As will be discussed in more detail herein, each of the modules 218, 220, 222, and 224 are used in conjunction with each other to complete a process for identifying contrasting items to provide to a user. Note that other embodiments may have fewer modules or more modules. For instance, all of the functionality described could be carried out in one single module, according to some embodiments. Likewise, the function attributed to one module in one embodiment may be carried out by another module in another embodiment. For instance, determining the most relevant item features can be performed by module 220 in some embodiments and may be performed by module 222 in some other embodiments. Numerous such variations will be apparent. To this end, the degree of modularity or integration may vary from one embodiment to the next, and the example modules provided are not intended to limit the present disclosure to a specific structure.

Computing device 202 can be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), virtual reality (VR) device or VR component (e.g., headset, hand glove, camera, treadmill, etc.) or other form of computing or telecommunications device that is capable of communication and that has sufficient processor power and memory capacity to perform the operations described in this disclosure. A distributed computational system can be provided including a plurality of such computing devices. Further note that device 202 may be, for example, a client in a client-server arrangement, wherein at least a portion of the item contrast system 216 is served or otherwise made accessible to device 202 via a network (e.g., the Internet and a local area network that is communicatively coupled to the network interface 212).

Computing device 202 includes one or more storage devices 208 or non-transitory computer-readable mediums 210 having encoded thereon one or more computer-executable instructions or software for implementing techniques as variously described in this disclosure. The storage devices 208 can include a computer system memory or random access memory, such as a durable disk storage (which can include any suitable optical or magnetic durable storage device, e.g., RAM, ROM, Flash, USB drive, or other semiconductor-based storage medium), a hard-drive, CD-ROM, or other computer readable mediums, for storing data and computer-readable instructions or software that implement various embodiments as taught in this disclosure. The storage device 208 can include other types of memory as well, or combinations thereof. The non-transitory computer-readable medium 210 can include, but are not limited to, one or more types of hardware memory, non-transitory tangible media (for example, one or more magnetic storage disks, one or more optical disks, one or more USB flash drives), and the like. The non-transitory computer-readable medium 210 included in the computing device 202 can store computer-readable and computer-executable instructions or software for implementing various embodiments (such as instructions for an operating system as well as natural language and textual comparison operations that are a part of item contrast system 216). The computer-readable medium 210 can be provided on the computing device 202 or provided separately or remotely from the computing device 202.

The computing device 202 also includes at least one processor 206 for executing computer-readable and computer-executable instructions or software stored in the storage device 208 or non-transitory computer-readable medium 210 and other programs for controlling system hardware. Processor 206 may have multiple cores to facilitate parallel processing or may be multiple single core processors. Any number of processor architectures can be used (e.g., central processing unit and co-processor, graphics processor, digital signal processor). Virtualization can be employed in the computing device 202 so that infrastructure and resources in the computing device 202 can be shared dynamically. For example, a virtual machine can be provided to handle a process running on multiple processors so that the process appears to be using only one computing resource rather than multiple computing resources. Multiple virtual machines can also be used with one processor. Network interface 212 can be any appropriate network chip or chipset which allows for wired or wireless connection between the computing device 202 and a communication network (such as local area network) and other computing devices and resources.

A user can interact with the computing device 202 through a networked output device 226, such as a screen or monitor, which can display a contrast region between different items as provided in accordance with some embodiments. Computing device 202 can include networked input or input/output devices 228 for receiving input from a user, for example, a keyboard, a joystick, a game controller, a pointing device (e.g., a mouse, a user's finger interfacing directly with a touch-sensitive display device, etc.), voice input, or any suitable user interface, including an AR headset. The computing device 202 may include any other suitable conventional I/O peripherals. In some embodiments, computing device 202 includes or is operatively coupled to various suitable devices for performing one or more of the aspects as variously described in this disclosure.

The computing device 202 can run any operating system, such as any of the versions of Microsoft® Windows® operating systems, the different releases of the Unix® and Linux® operating systems, any version of the MacOS® for Macintosh computers, any embedded operating system, any real-time operating system, any open source operating system, any proprietary operating system, any operating systems for mobile computing devices, or any other operating system capable of running on the computing device 202 and performing the operations described in this disclosure. In an embodiment, the operating system can be run on one or more cloud machine instances.

In other embodiments, the functional components/modules can be implemented with hardware, such as gate level logic (e.g., FPGA) or a purpose-built semiconductor (e.g., ASIC). Still other embodiments can be implemented with a microcontroller having several input/output ports for receiving and outputting data, and several embedded routines for carrying out the functionality described in this disclosure. In a more general sense, any suitable combination of hardware, software, and firmware can be used, as will be apparent.

As will be appreciated in light of this disclosure, the various modules and components of the system, such as item contrast system 216, co-occurrence module 218, relevance scoring module 220, similarity module 222, contrast selection module 224, GUI 214, or any combination of these, may be implemented in software, such as a set of instructions (e.g., HTML, XML, C, C++, object-oriented C, JavaScript®, Java®, BASIC, etc.) encoded on any machine-readable medium or computer program product (e.g., hard drive, server, disc, or other suitable non-transitory memory or set of memories), that when executed by one or more processors, cause the various methodologies provided in this disclosure to be carried out. It will be appreciated that, in some embodiments, various functions and data transformations performed by the user computing system, as described in this disclosure, can be performed by one or more suitable processors in any number of configurations and arrangements, and that the depicted embodiments are not intended to be limiting. Various components of this example embodiment, including the computing device 202, can be integrated into, for example, one or more desktop or laptop computers, workstations, tablets, smart phones, game consoles, VR devices, set-top boxes, or other such computing devices. Other componentry and modules typical of a computing system, will be apparent.

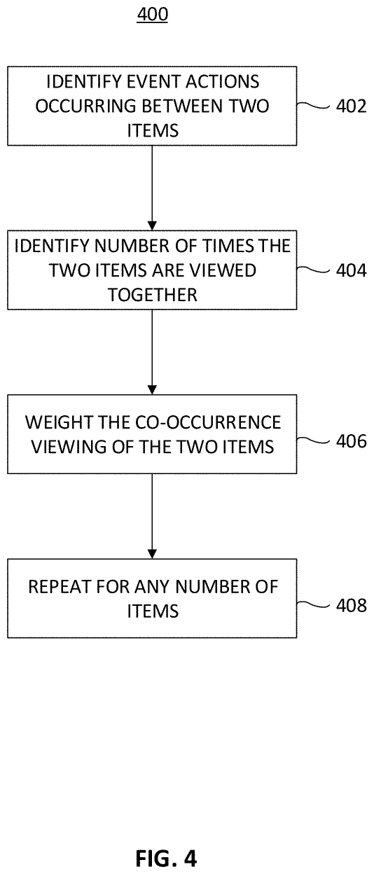

According to some embodiments, co-occurrence module 218 is configured to track and identify event actions that occur between two given items of a plurality of cataloged items. In some examples, the plurality of cataloged items include items associated with a particular website or store, such as items being sold on an online store. Event actions can be any actions performed by a user that involve an association being made between two items of the plurality of cataloged items. Some examples of event actions in the context of an online store include any time items are added together into a cart, any time items are ordered together, any time items are viewed together, or any time items are added to a wish list together. Each of these actions are tracked by co-occurrence module 218, which can use this data to generate a database of co-occurrence scores between items. Further details of how event actions are tracked, and how co-occurrence scores are generated are provided herein with reference to FIG. 4.

According to some embodiments, relevance scoring module 220 uses catalog data associated with each of the plurality of cataloged items to determine relevance scores between any two given items of the plurality of cataloged items. The relevance scores may be an agglomeration of different comparison metrics associated with different text fields of the cataloged data. For example, comparisons between the item names can provide a name relevancy value, comparisons between item categories can provide a category relevancy value, and so forth. Ultimately, each of the relevancy values can be combined to generate a relevance score between two items.

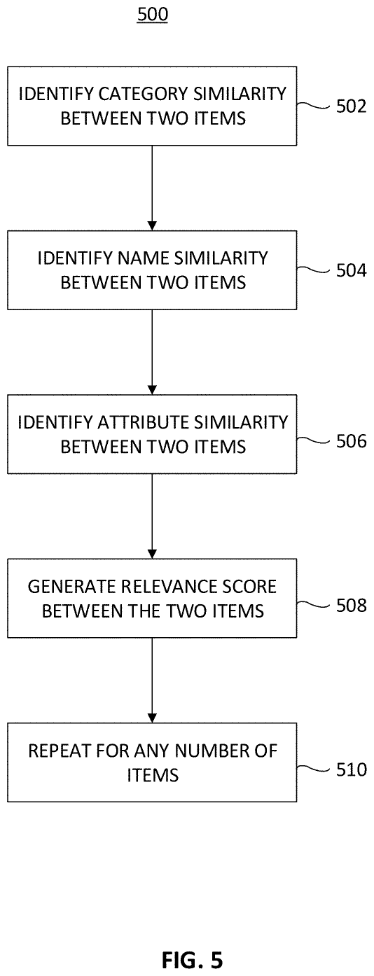

The text fields associated with different items can be compared using a variety of natural language techniques. Example techniques such as vectorizing, one hot encoding, TFIDF weighting, parsing, stop word removal, speech tagging, sparse data processing, and/or dense data processing can be used to characterize the various text fields into a form that can be quantitatively compared using one or more different comparison techniques. Example comparison techniques include one or more of dot product determination, cosine similarity analysis, L2 analysis, or Hamming distance determination. Further details of how relevancy scores between items are generated are provided herein with reference to FIG. 5.

According to some embodiments, similarity module 222 is configured to take both the co-occurrence scores and the relevancy scores and generate similarity scores between any two given items of the plurality of cataloged items. Accordingly, the similarity scores represent both user-based data and catalog similarity between items thus allowing for more robust contrasts to be made between the items. All of the similarity scores can be arranged in a matrix where clusters of similar similarity scores can be identified and re-arranged in the matrix. Once provided a target item, other contrasting items can be quickly found in the matrix on the same row or column as the target item.

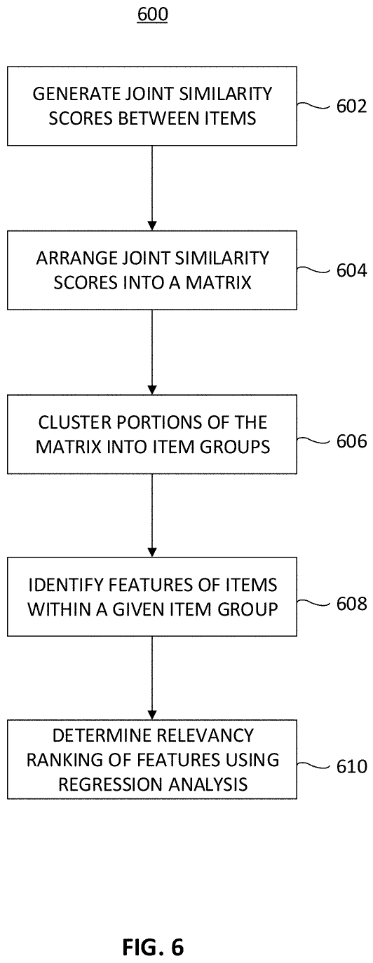

According to some embodiments, similarity module 222 is further configured to identify the item features that are most relevant to provide to a user. Feature relevancy may be related to the feature's influence on the price of the item and is determined using a regression analysis on the price with the item features as the inputs to the regression. Item features may be ranked based on their relevancy. According to some embodiments, item features are ranked within a given clustered group of items from the matrix. Further details of the operations of similarity module 222 are provided herein with reference to FIG. 6.

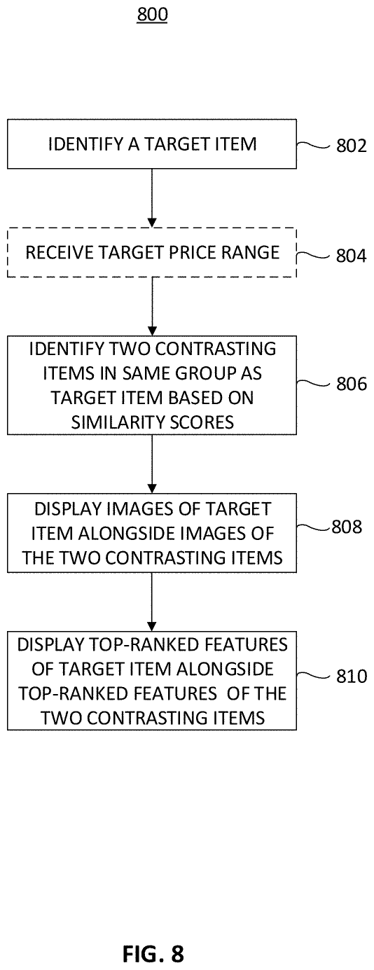

According to some embodiments, contrast selection module 224 is configured to receive a target item and identify contrasting items to display along with the target item to a user. The contrasting items may be chosen based on their similarity scores with the target item and based on how close those similarity scores are to one another. For example, two contrasting items may be selected that each have a high similarity score to the target item and are within a threshold percentage of one another. The threshold percentage may be, for instance, 5%, 6%, 7%, 8%, 9%, 10%, 15%, or 20%, depending on the application and according to some example embodiments. In one particular example, two contrasting items having similarity scores of 93 and 95 (out of 100) with the target item may be selected due to their high scores and closeness to each other. In some embodiments, more emphasis is placed on identifying items with similarity scores to the target item that are close to one another. For example, if item 1 has a similarity score to the target item of 95, item 2 has a similarity score to the target item of 76, and item 3 has a similarity score to the target item of 73, contrast selection module 224 would provide items 2 and 3 to the user as the scores are relatively closer to one another compared to item 1. In some example embodiments, the two contrasting items are also chosen such that one of the contrasting items is more expensive than the target item and the other contrasting item is less expensive than the target item. Further details of the operations of the contrast selection module 224 are provided herein with reference to FIG. 8.

### METHODOLOGY

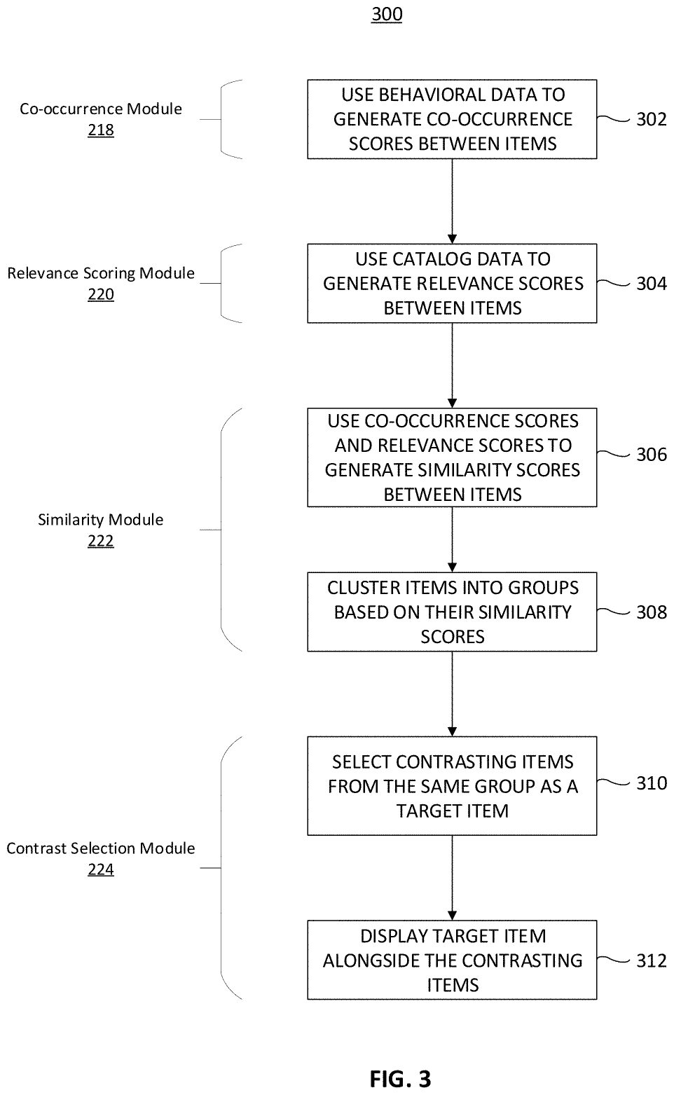

FIG. 3 illustrates an example method 300 of identifying contrasting items to provide to a user, according to an embodiment. As discussed above, some of the operations of method 300 are performed to generate similarity scores between cataloged items while other operations are performed upon receiving a target item being viewed by a user or otherwise being indicated by the user. The operations, functions, or actions described in the respective blocks of example method 300 may be stored as computer-executable instructions in a non-transitory computer-readable medium, such as a memory and/or a data storage of a computing system. In some embodiments, the operations of the various blocks of method 300 are performed by item contrast system 216. As will be further appreciated in light of this disclosure, for this and other processes and methods disclosed herein, the functions performed in method 300 may be implemented in a differing order. Additionally, or alternatively, two or more operations may be performed at the same time or otherwise in an overlapping contemporaneous fashion.

According to some embodiments, the cataloged items include any number of items collected together with some association between the items. For example, the cataloged items can include all items being sold by a particular retailer, a selected subset of the items being sold by a particular retailer, frequently sold items, or all items viewed within a given time period by a user, to name a few examples. In some embodiments, any traditional recommendation technique can be used to identify a plurality of similar items to a target item, and the similar items then make up the cataloged items for further analysis using method 300 to identify contrasting items from the cataloged items.

At block 302, user-based data is tracked and used to generate co-occurrence scores between any given two items of the plurality of cataloged items. According to some embodiments, the operations of block 302 are performed by co-occurrence module 218. In some examples, event actions between items are documented based on online interactions between users and the various items of the plurality of cataloged items associated with a given website or any other networked source. Some examples of event actions in the context of an online store include any time items are added together into a cart, any time items are ordered together, any time items are viewed together, or any time items are added to a wish list together. In one example, item co-views can be tracked to determine co-occurrence scores between items based on how often they are viewed together by users. In some embodiments, the co-occurrence scores between any two items of the plurality of cataloged items are stored in a dynamic database that is updated as user activity data continues to be tracked.

At block 304, catalog data (e.g., text fields) of the items is compared to generate relevance scores between any given two items of the plurality of cataloged items. According to some embodiments, the operations of block 304 are performed by relevance scoring module 220. The relevance scores may be an agglomeration of different comparison metrics associated with different text fields of the cataloged data. For example, comparisons can be made between item names, item descriptions, item categories, item prices, and/or item features. Each comparison may be performed separately, thus generating different relevancy values that can be combined to generate a relevance score between two items. The text fields associated with different items can be compared using a variety of natural language techniques. Example techniques such as vectorizing, one hot encoding, TFIDF weighting, parsing, stop word removal, speech tagging, sparse data processing, and/or dense data processing can be used to characterize the various text fields into a form that can be quantitatively compared using one or more different comparison techniques. Example comparison techniques include one or more of dot product determination, cosine similarity analysis, L2 analysis, or Hamming distance determination. In one example, item categories, item names, and item features are specifically compared between two items to determine a relevance score between the two items. In some embodiments, the relevancy scores between any two items of the plurality of cataloged items are stored in a dynamic database that is updated whenever new items are added to the plurality of cataloged items and/or when any item catalog data is edited.

At block 306, the item co-occurrence scores and item relevance scores are combined to generate similarity scores between any given two items of the plurality of cataloged items. According to some embodiments, the operations of block 306 are performed by similarity module 222. The similarity scores represent both user-based data and catalog similarity between items thus allowing for more robust contrasts to be made between the items. In some embodiments, the similarity scores are arranged into a matrix with all of the cataloged items along the X and Y axes of the matrix and the intersection between any two items includes the similarity score between those two items.

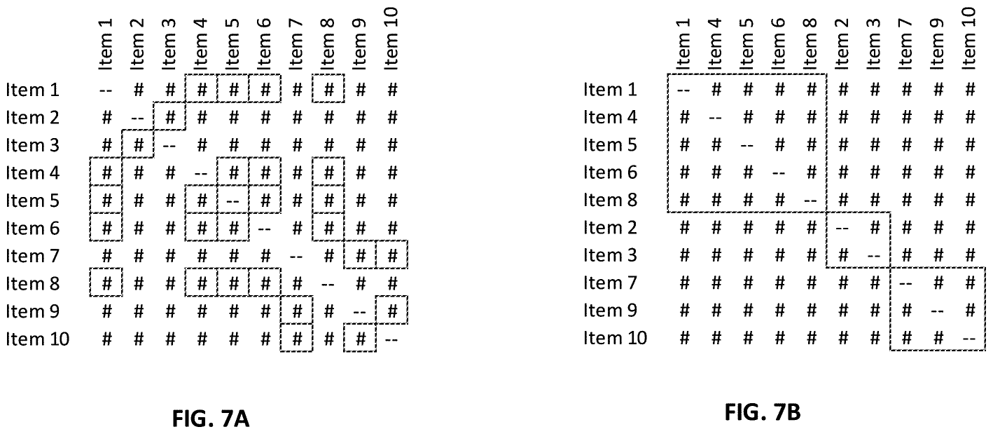

At block 308, the items are clustered into groups based on their similarity scores with each other. According to some embodiments, the operations of block 308 are performed by similarity module 222. For example, the items can be rearranged along X and Y axes of a similarity score matrix in order to create clusters within the matrix of items that share a high affinity (e.g., higher similarity scores) for one another. An example of the matrix clustering is provided herein with reference to FIGS. 7A and 7B. Spectral clustering methods may be used to identify item clusters in the similarity matrix. Example clustering methods for identifying an ideal number of clusters to include as many of the items as possible include the Calinski-Harabasz index function or an Eigengap heuristic.

It should be noted that the operations performed in each of boxes 302-308 may be considered pre-processing operations that are performed by any computing device before any items are identified that contrast with a target item. In other words, these operations set up a database of similarity scores between items (e.g., arranged as a matrix of scores) to be used by the proceeding operations of method 300.

At block 310, contrasting items from the same clustered group as a target item are selected. According to some embodiments, the operations of block 310 are performed by contrast selection module 224. The target item may be any item currently being viewed by a user online or otherwise being indicated by the user in any fashion. Once identified, contrasting items from the same clustered group as the target item can be quickly identified by scanning along the row or column associated with the target item in the matrix. The contrasting items may be chosen based on their similarity scores with the target item and based on how close those similarity scores are to one another. For example, two contrasting items may be selected that each have a high similarity score to the target item and are within a threshold percentage of one another, as explained above. In some embodiments, the two contrasting items are also chosen such that one of the contrasting items is more expensive than the target item and the other contrasting item is less expensive than the target item.

At block 312, the target item is displayed to the user along with the contrasting items identified in block 310. According to some embodiments, the operations of block 312 are performed by contrast selection module 224. A picture of the target item may be displayed adjacent to pictures of the contrasting items. In one example, the target item is displayed between two contrasting items with one on either side of the target item. In some embodiments, item features of each of the target item and contrasting items are listed along with the associated item. According to some embodiments, the item features having the largest influence on the price of the associated item are selected to be displayed.

FIG. 4 illustrates an example flowchart providing further operations of block 302 (also referred to herein as method 400) from method 300, according to an embodiment. The operations, functions, or actions described in the respective blocks of example method 400 may be stored as computer-executable instructions in a non-transitory computer-readable medium, such as a memory and/or a data storage of a computing system. As will be further appreciated in light of this disclosure, for this and other processes and methods disclosed herein, the functions performed in method 400 may be implemented in a differing order. Additionally, or alternatively, two or more operations may be performed at the same time or otherwise in an overlapping contemporaneous fashion. According to some embodiments, the functions performed in method 400 are executed by co-occurrence module 218.

Method 400 begins with block 402 where event actions are identified and tracked between any two given items of the plurality of cataloged items, according to some embodiments. Event actions can be any actions performed by a user that involve an association being made between two items of the plurality of cataloged items. Some examples of event actions in the context of an online store include any time items are added together into a cart, any time items are ordered together, any time items are viewed together, or any time items are added to a wish list together.

At block 404, the number of times the two given items are viewed together (co-views) by any number of different users is identified, according to some embodiments. The items may be viewed together in a number of different contexts. For example, two items viewed online by a user one after the other or viewed within a short time of one another (e.g., within the same online session) can count as one instance of co-viewing between the two items.

At block 406, the number of co-views for any given two items is weighted based on the maximum number of co-views between the various pairs of items of the plurality of cataloged items, according to some embodiments. For example, for two given items A and B, the co-occurrence score (coSim) between the items is determined by dividing their number of co-views by the maximum determined number of co-views

$$coSim = \frac{coOccur ( A , B )}{max ( {coOccur ( ; )}^{.} )} \qquad ( 1 )$$

The max function returns the maximum determined total number of co-views found amongst all of the items in the plurality of cataloged items. Accordingly, the co-occurrence score for the two items having the maximum number of co-views will be 1 and the co-occurrence scores between all other items will be some number between 0 and 1.

At block 408, the operations of blocks 402-406 are repeated to generate co-occurrence scores between all items such that any given item has a co-occurrence score with each other item of the plurality of cataloged items, according to some embodiments. Example co-occurrence scores calculated between five different items are provided below in table 1.

TABLE 1
Example of co-occurrence scores between
5 items arranged in a matrix format.

| | 1CB- | 1CB- | 1CB- | 1CB- | 1CB- |
|---|---|---|---|---|---|
| | ACEX- | AHSD- | AHSD- | APLC- | APLC- |
| | Y100- | W13MM- | Y13MM- | R1000- | SS000- |
| | 00 | 00 | 00 | 00 | 00 |
| 1CB-ACEX- | 0.000000 | 0.000556 | 0.002778 | 0.005000 | 0.010000 |
| Y100-00 | | | | | |
| 1CB-AHSD- | 0.000556 | 0.000000 | 0.038889 | 0.002222 | 0.001111 |
| W13MM-00 | | | | | |
| 1CB-AHSD- | 0.002778 | 0.038889 | 0.000000 | 0.001667 | 0.000556 |
| Y13MM-00 | | | | | |
| 1CB-APLC- | 0.005000 | 0.002222 | 0.001667 | 0.000000 | 0.009444 |
| R1000-00 | | | | | |
| 1CB-APLC- | 0.010000 | 0.001111 | 0.000556 | 0.009444 | 0.000000 |
| SS000-00 | | | | | |

The items are listed by their cataloged serial numbers along the X and Y axes of the matrix in Table 1. The co-occurrence scores range between 0 and 1. In some embodiments, the co-occurrence score between any item and itself is 0, as observed along the diagonal values in Table 1.

FIG. 5 illustrates an example flowchart providing further operations of block 304 (also referred to herein as method 500) from method 300, according to an embodiment. The operations, functions, or actions described in the respective blocks of example method 500 may be stored as computer-executable instructions in a non-transitory computer-readable medium, such as a memory and/or a data storage of a computing system. As will be further appreciated in light of this disclosure, for this and other processes and methods disclosed herein, the functions performed in method 500 may be implemented in a differing order. Additionally, or alternatively, two or more operations may be performed at the same time or otherwise in an overlapping contemporaneous fashion. According to some embodiments, the functions performed in method 500 are executed by relevance scoring module 220.

Method 500 begins with block 502 where a category similarity value is determined between two given items of the plurality of cataloged items, according to some embodiments. Category similarity between two given items may be one component of determining an overall relevance score between the two given items. Items can belong to more than one category. Accordingly, category vectors can be generated for two given items A and B (catA and catB, respectively). The vectors are populated such that catA=1 for any category that item A belongs to and otherwise, catA=0. The same holds true for catB. According to some embodiments, a dot product similarity metric is determined between the category vectors to generate the category similarity value as shown below.

$${catSim}_{A , B} = \frac{{\sum }_{i = 1}^{C} {catA}_{i} {catB}_{i}}{max ( catSim )} \qquad ( 2 )$$

Where C represents the total number of different categories. Similar to co-occurrence scores, the category similarity value between two items is weighted based on the items having the highest category similarity value. Accordingly, the category similarity value for the two items having the maximum category similarity value will be 1 and the category similarity values between all other items will be some number between 0 and 1.

At block 504, a name similarity value is determined between the two given items of the plurality of cataloged items, according to some embodiments. Name similarity between two given items may be one component of determining an overall relevance score between the two given items. Briefly, term frequency-inverse document frequency (TF-IDF) vectors can be created for each of the two given items A and B (namA and namB, respectively). TF-IDF provides a numeric statistic that highlights words that are more interesting, e.g., more frequently appearing across the item names. According to some embodiments, a cosine similarity metric is determined between the TF-IDF vectors to generate the name similarity value (namSim) as shown below.

$${namSim}_{A , B} = \frac{{\sum }_{i = 1}^{W} {namA}_{i} {namB}_{i}}{\sqrt{{\sum }_{i = 1}^{W} {namA}_{i}^{2}} \sqrt{{\sum }_{i = 1}^{W} {namB}_{i}^{2}}} \qquad ( 3 )$$

Where W represents the total number of words across all of the different item names. The name similarity value between any two given items will be some number between 0 and 1, with higher values representing a closer match in the names.

At block 506, a feature similarity value is determined between the two given items of the plurality of cataloged items, according to some embodiments. Feature similarity between two given items may be one component of determining an overall relevance score between the two given items. Briefly, feature vectors can be created for each of the two given items A and B (attA and attB, respectively). The vectors are populated such that attA=1 for any feature that item A has and otherwise, attA=0. The same holds true for attB. According to some embodiments, a dot product similarity metric is determined between the feature vectors to generate the feature similarity value (attSim) as shown below.

$${attSim}_{A , B} = \frac{{\sum }_{i = 1}^{A} {attA}_{i} {attB}_{i}}{max ( attSim )} \qquad ( 4 )$$

Where A represents the total number of different features. Similar to co-occurrence scores, the feature similarity value between two items is weighted based on the items having the highest feature similarity value. Accordingly, the feature similarity value for the two items having the maximum feature similarity value will be 1 and the feature similarity values between all other items will be some number between 0 and 1.

At block 508 the relevance score between the two given items is determined. According to some embodiments, the relevance score is the product of each of the category similarity value, name similarity value, and feature similarity value between the two items A and B (e.g., catSim_{A,B} * namSim_{A,B} * attSim_{A,B}) Although only three relevancy metrics were used in this example to generate the relevance score, any number of different text-based comparisons can be made between two items using the cataloged data associated with the items.

At block 510, the operations of blocks 402-408 are repeated to generate relevance scores between all items such that any given item has a relevance score with each other item of the plurality of cataloged items, according to some embodiments.

FIG. 6 illustrates an example flowchart providing further operations of blocks 306 and 308 (also referred to herein as method 600) from method 300, according to an embodiment. The operations, functions, or actions described in the respective blocks of example method 600 may be stored as computer-executable instructions in a non-transitory computer-readable medium, such as a memory and/or a data storage of a computing system. As will be further appreciated in light of this disclosure, for this and other processes and methods disclosed herein, the functions performed in method 600 may be implemented in a differing order. Additionally, or alternatively, two or more operations may be performed at the same time or otherwise in an overlapping contemporaneous fashion. According to some embodiments, the functions performed in method 600 are executed by similarity module 222.

Method 600 begins with block 602 where similarity scores are generated between pairs of items of the plurality of cataloged items. According to some embodiments, a similarity score, also referred to as a joint similarity, between a given pair of items A and B is generated based on both the co-occurrence score and the relevance score between items A and B. According to an embodiment, the joint similarity can be found as the geometric mean of the co-occurrence score and the relevance score. One or more of the category similarity value, name similarity value, and feature similarity value that make up the relevance score can be weighted differently than the other values when determining the similarity score. For example, the name similarity value between items A and B can be found to be more impactful on item similarity than the other values, and is thus weighted more heavily when determining the joint similarity (joiSim) score between items A and B as shown below.

joiSim_{A,B}=(coSim_{A,B}catSim_{A,B}attSim_{A,B}namSim_{A,B}⁴)^{1/8} (5)

At block 604, the joint similarity scores generated between each pair of items of the plurality of cataloged items are arranged in a matrix with the items of the plurality of cataloged items along the X and Y axes of the matrix and the similarity scores between items at each intersection, according to some embodiments. FIG. 7A illustrates an example similarity matrix for a catalog that includes 10 items. Similarity scores are provided in the matrix at each intersection between items, except for the locations that represent comparing an item to itself (along the diagonal of the matrix). In the illustrated example, similarity scores above a certain threshold have been outlined with boxes to show what item pairs have a high similarity to each other. For similarity scores between 0 and 1, example thresholds include 0.5, 0.6, 0.7, 0.8, or 0.9. For example, items 1, 4, 5, 6, and 8 share high similarity scores with each other, items 2 and 3 share high similarity scores with each other, and items 7, 9, and 10 share high similarity scores with each other. Since the matrix is generated using items provided in ascending order along the X and Y axes, the item pairs having high similarity to one another can be scattered around the matrix with no discernable order.

At block 606, the matrix of similarity scores is clustered into item groups based on their similarity scores, according to some embodiments. For example, the items can be rearranged along X and Y axes of a similarity score matrix in order to create clusters within the matrix of items that share a high affinity (e.g., higher similarity scores) for one another. Spectral clustering methods may be used to identify item clusters in the similarity matrix. Example clustering methods for identifying an ideal number of clusters to include as many of the items as possible include the Calinski-Harabasz index function or an Eigengap heuristic. In some embodiments, spectral clustering of the similarity matrix is run multiple times using varying input parameters (such as the total number of clusters to form) and the configuration that scores the highest according to the Calinski-Harabasz index is selected. FIG. 7B illustrates the example matrix from FIG. 7A following spectral clustering to form three clusters or clustered groups of items (identified by the boxes). By clustering the items together, finding contrasting items having high similarity scores with a target item is greatly simplified and reduces the required processing power and processing time, which becomes especially important when dealing with hundreds, thousands, or even more cataloged items.

At block 608, item features are identified for the items within a given item group or cluster, according to some embodiments. Each of the items of any given item group have cataloged item features that describe different aspects of the items. For example, a jewelry ring may include features such as band material, center stone, center stone cut, side stones, etc. In some examples, item features include non-physical characteristics, such as whether the item can be financed or whether it is a “one-of-a-kind” piece. Any number of different types of features will be appreciated based on the type of item.

At block 610, the identified item features from a given group of items are ranked based on their relevancy, according to some embodiments. The relevancy may be related to the prices of the various items in the group and how much influence each feature has on the item price. Those features with a higher influence on the price can be ranked higher than features with a lower influence on the price. According to some embodiments, a regression analysis is performed on the item prices using the item features as inputs to the regression. The output of the regression analysis includes a ranking of the item features corresponding to their influence on the prices of the items in the group. For example, for a group of jewelry rings, it is likely that the center stone feature makes a large influence on what the price of the ring is, and thus this feature may be highly ranked after performing the regression analysis. The ranking of the features may be used when choosing which features of an item to display to a user. In other words, only a certain number of top-ranked features may be selected to be displayed to the user.

FIG. 8 illustrates an example flowchart providing further operations of blocks 310 and 312 (also referred to herein as method 800) from method 300, according to an embodiment. The operations, functions, or actions described in the respective blocks of example method 800 may be stored as computer-executable instructions in a non-transitory computer-readable medium, such as a memory and/or a data storage of a computing system. As will be further appreciated in light of this disclosure, for this and other processes and methods disclosed herein, the functions performed in method 800 may be implemented in a differing order. Additionally, or alternatively, two or more operations may be performed at the same time or otherwise in an overlapping contemporaneous fashion. According to some embodiments, the functions performed in method 800 are executed by contrast selection module 222.

Method 800 begins with block 802 where a target item is identified. According to some embodiments, the target item is any item that a user is currently viewing or otherwise accessing online, such as through a website. For example, if a user is viewing a vase through an online marketplace, then the vase currently being viewed is identified as the target item. In some other embodiments, the user may select the target item from a list items in the plurality of cataloged items. In yet other embodiments, the user may identify the target item via entering the name of the target item through a text input or voice.

At block 804, a target price range is optionally received by the user. The target price range can be used to constrain which other items are selected as contrasting items to the target item by ensuring that the selected contrasting items fall within the selected price range. The price range may be selected from a list of options provided to the user, or the price range may be entered manually by the user, to name a few examples.

At block 806, at least two contrasting items are selected from the same item group as the target item, according to some embodiments. For example, the at least two contrasting items can be selected from the same row or same column as the target item within the identified item group in the similarity matrix. The at least two contrasting items have high similarity scores with the target item (as they are in the same group with the target item). Furthermore, in accordance with some embodiments, the at least two contrasting items have similarity scores with the target that are within a threshold percentage of one another. The threshold percentage may be, for instance, 5%, 6%, 7%, 8%, 9%, 10%, 15%, or 20%, depending on the application, according to some embodiments. In one particular example, two contrasting items having similarity scores of 93 and 95 (out of 100) with the target item may be selected due to their closeness to each other. In some embodiments, more emphasis is placed on identifying items with similarity scores to the target item that are close to one another. For example, when selecting two contrasting items, if item 1 has a similarity score to the target item of 95, item 2 has a similarity score to the target item of 76, and item 3 has a similarity score to the target item of 73, then items 2 and 3 are provided to the user as the scores are relatively closer to one another compared to item 1, even though item 1 has a higher overall similarity score with the target item. In some embodiments, when choosing two contrasting items, they are chosen such that one of the contrasting items is more expensive than the target item and the other contrasting item is less expensive than the target item. Furthermore, if a target price range has been received, then only contrasting items that fall within the target price range can be selected.

According to some embodiments, the at least two contrasting items are further selected based on other input received by the user with regards to the item features. As illustrated in FIG. 1C, the user may select one or more particular item features, such that only contrasting items that share the same selected item attribute(s) as the target item can be selected to display alongside the target item.

At block 808, images of the target item along with images of the at least two contrasting items are displayed to a user. The images may be displayed adjacent to one another. In one example, the image of the target item is between the images of the at least two contrasting items, such as the examples illustrated in FIGS. 1A-1C.

At block 810, features of the target item and contrasting items are also displayed to the user. According to some embodiments, only the top-ranked features are provided as determined in block 610 from method 600. For example, only the top 3 features may be provided to a user as illustrated in FIG. 1A. In some other examples, the user can select how many features they wish to see for each of the items, and the selected number of top ranked features are provided.

### FURTHER EXAMPLES

Example 1 is a method for identifying contrasting items to a target item being viewed by a user, the method comprising: generating, using a co-occurrence module, a co-occurrence score between each item of a plurality of cataloged items against each other item of the plurality of cataloged items, wherein the co-occurrence score between two items is based on one or more documented event actions by one or more users with regards to co-viewing the two items; generating, using a relevance scoring module, an item relevance score between each item of the plurality of cataloged items against each other item of the plurality of cataloged items, wherein the item relevance score between two items is based on comparisons between text fields associated with the two items; generating, using a similarity module, similarity scores between each item of the plurality of cataloged items against each other item of the plurality of cataloged items by determining the geometric mean of a product of the co-occurrence scores and the item relevance scores between the items; identifying, using a contrast selection module, a first item and a second item, the first item having a first similarity score with the target item and the second item having a second similarity score with the target item, the first and second similarity scores being within a threshold of one another; and causing, using the contrast selection module, simultaneous display of the target item, the first item, and the second item.

Example 2 includes the subject matter of Example 1, wherein each of the target item, the first item, and the second item are products being offered for sale in an online environment, and the first item has a higher price than the target item and the second item has a lower price than the target item.

Example 3 includes the subject matter of Example 2, wherein the price of the first item and the price of the second item are within a given price range provided as input by the user.

Example 4 includes the subject matter of any of Examples 1 through 3, and includes: identifying, using the similarity module, one or more features of each of the target item, the first item, and the second item that have a highest influence on a price of each of the items; and causing, using the contrast selection module, display of the one or more features of each of the target item, the first item, and the second item.

Example 5 includes the subject matter of Example 4, wherein identifying the one or more features comprises: performing a regression analysis on prices of at least the target item, first item, and second item using features of the items as inputs to determine a ranking of the features based on their influence on the prices; and selecting one or more of the top ranked features as the one or more features.

Example 6 includes the subject matter of any of Examples 1 through 5, wherein the one or more event actions comprise one or more of adding the first item and the second item to a cart together, adding the first item and the second item to a wish list together, or ordering the first item and the second item together.

Example 7 includes the subject matter of any of Examples 1 through 6, wherein the text fields of the first item and the second item comprise one or more of item name, item description, item category, item price, or one or more item features.

Example 8 includes the subject matter of any of Examples 1 through 7, wherein generating the item relevance scores comprises using one or more natural language techniques to characterize the text fields, the one or more natural language techniques including at least one of vectorizing, one hot encoding, TFIDF weighting, parsing, stop word removal, speech tagging, sparse data processing, or dense data processing.

Example 9 includes the subject matter of Example 8, wherein generating the item relevance scores comprises comparing the characterized text fields using a comparison technique that includes at least one of a dot product determination, cosine similarity analysis, L2 analysis, or Hamming distance determination.

Example 10 includes the subject matter of any of Examples 1 through 9, and includes generating, using the similarity module, a similarity matrix of the similarity scores.

Example 11 includes the subject matter of Example 10, and includes clustering, using the similarity module, the items of the plurality of cataloged items into groups within the similarity matrix based on their similarity scores using a spectral clustering technique.

Example 12 includes the subject matter of Example 11, wherein identifying the first item and the second item comprises identifying the first item and the second item within the same group as the target item.

Example 13 includes the subject matter of Example 11 or 12, wherein the spectral clustering technique comprises a Calinski-Harabasz index function or an Eigengap heuristic.

Example 14 is a system configured to identify contrasting items to a target item being viewed by a user, the system comprising: at least one processor; a co-occurrence module, executable by the at least one processor, and configured to generate a co-occurrence score between each item of a plurality of cataloged items against each other item of the plurality of cataloged items, wherein the co-occurrence score between two items is based on one or more documented event actions by one or more users with regards to co-viewing the two items; a relevance scoring module, executable by the at least one processor, and configured to generate an item relevance score between each item of the plurality of cataloged items against each other item of the plurality of cataloged items, wherein the item relevance score between two items is based on comparisons between text fields associated with the two items; a similarity module, executable by the at least one processor, and configured to generate similarity scores between each item of the plurality of cataloged items against each other item of the plurality of cataloged items by taking a geometric mean of a product of the co-occurrence scores and the item relevance scores between the items; and a contrast selection module, executable by the at least one processor. The contrast selection module is configured to identify a first item and a second item, the first item having a first similarity score with the target item and the second item having a second similarity score with the target item, the first and second similarity scores being within a threshold of one another, and cause simultaneous display of the target item, the first item, and the second item.

Example 15 includes the subject matter of Example 14, wherein each of the target item, the first item, and the second item are products being offered for sale in an online environment, and the first item has a higher price than the target item and the second item has a lower price than the target item.

Example 16 includes the subject matter of Example 15, wherein the price of the first item and the price of the second item are within a given price range provided as input by the user.

Example 17 includes the subject matter of any of Examples 14 through 16, wherein the similarity module is configured to identify one or more features of each of the target item, the first item, and the second item that have a highest influence on a price of each of the items, and wherein the contrast selection module is configured to cause display of the one or more features of each of the target item, the first item, and the second item.

Example 18 includes the subject matter of Example 17, wherein the similarity module is configured to: perform a regression analysis on prices of at least the target item, first item, and second item using features of the items as inputs to determine a ranking of the features based on their influence on the prices; and select one or more of the top ranked features as the one or more features.

Example 19 includes the subject matter of any of Examples 14 through 18, wherein the one or more event actions comprise one or more of adding the first item and the second item to a cart together, adding the first item and the second item to a wish list together, or ordering the first item and the second item together.

Example 20 includes the subject matter of any of Examples 14 through 19, wherein the text fields of the first item and the second item comprise one or more of item name, item description, item category, item price, or one or more item features.

Example 21 includes the subject matter of any of Examples 14 through 20, wherein the relevance scoring module is configured to generate the item relevance scores by using one or more natural language techniques to characterize the text fields, the one or more natural language techniques including at least one of vectorizing, one hot encoding, TFIDF weighting, parsing, stop word removal, speech tagging, sparse data processing, or dense data processing.

Example 22 includes the subject matter of Example 21, wherein the relevance scoring module is configured to generate the item relevance scores by comparing the characterized text fields using a comparison technique that includes at least one of a dot product determination, cosine similarity analysis, L2 analysis, or Hamming distance determination.

Example 23 includes the subject matter of any of Examples 14 through 22, wherein the similarity module is configured to generate a similarity matrix of the similarity scores

Example 24 includes the subject matter of Example 23, wherein the similarity module is configured to cluster the items of the plurality of cataloged items into groups within the similarity matrix based on their similarity scores using a spectral clustering technique.

Example 25 includes the subject matter of Example 24, wherein the contrast selection module is configured to identify the first item and the second item within the same group as the target item.

Example 26 includes the subject matter of Example 24 or 25, wherein the spectral clustering technique comprises a Calinski-Harabasz index function or an Eigengap heuristic.

Example 27 is a computer program product including one or more non-transitory machine-readable mediums having instructions encoded thereon that when executed by at least one processor cause a process to be carried out for identifying contrasting items to a target item being viewed by a user, the process comprising: generating a co-occurrence score between each item of a plurality of cataloged items against each other item of the plurality of cataloged items, wherein the co-occurrence score between two items is based on one or more documented event actions by one or more users with regards to co-viewing the two items; generating an item relevance score between each item of the plurality of cataloged items against each other item of the plurality of cataloged items, wherein the item relevance score between two items is based on comparisons between text fields associated with the two items; generating similarity scores between each item of the plurality of cataloged items against each other item of the plurality of cataloged items by determining the geometric mean of a product of the co-occurrence scores and the item relevance scores between the items; identifying a first item and a second item, the first item having a first similarity score with the target item and the second item having a second similarity score with the target item, the first and second similarity scores being within a threshold of one another; and causing simultaneous display of the target item, the first item, and the second item.

Example 28 includes the subject matter of Example 27, wherein each of the target item, the first item, and the second item are products being offered for sale in an online environment, and the first item has a higher price than the target item and the second item has a lower price than the target item.

Example 29 includes the subject matter of Example 28, wherein the price of the first item and the price of the second item are within a given price range provided as input by the user.

Example 30 includes the subject matter of any of Examples 27 through 29, wherein the process comprises: identifying one or more features of each of the target item, the first item, and the second item that have a highest influence on a price of each of the items; and causing display of the one or more features of each of the target item, the first item, and the second item.

Example 31 includes the subject matter of Example 30, wherein identifying the one or more features comprises: performing a regression analysis on prices of at least the target item, first item, and second item using features of the items as inputs to determine a ranking of the features based on their influence on the prices; and selecting one or more of the top ranked features as the one or more features.

Example 32 includes the subject matter of any of Examples 27 through 31, wherein the one or more event actions comprise one or more of adding the first item and the second item to a cart together, adding the first item and the second item to a wish list together, or ordering the first item and the second item together.

Example 33 includes the subject matter of any of Examples 27 through 33, wherein the text fields of the first item and the second item comprise one or more of item name, item description, item category, item price, or one or more item features.

Example 34 includes the subject matter of any of Examples 27 through 33, wherein generating the item relevance scores comprises using one or more natural language techniques to characterize the text fields. The one or more natural language techniques may include, for instance, at least one of vectorizing, one hot encoding, TFIDF weighting, parsing, stop word removal, speech tagging, sparse data processing, or dense data processing).

Example 35 includes the subject matter of Example 34, wherein generating the item relevance scores comprises comparing the characterized text fields. The comparing may be accomplished, for instance, using a comparison technique that includes at least one of a dot product determination, cosine similarity analysis, L2 analysis, or Hamming distance determination.

Example 36 includes the subject matter of any of Examples 27 through 35, the process comprising generating a similarity matrix of the similarity scores.

Example 37 includes the subject matter of Example 36, wherein, the process comprising clustering the items of the plurality of cataloged items into groups based on their similarity scores using a spectral clustering technique.

Example 38 includes the subject matter of Example 37, wherein identifying the first item and the second item comprises identifying the first item and the second item within the same group as the target item.

Example 39 includes the subject matter of Example 37 or 38, wherein the spectral clustering technique comprises a Calinski-Harabasz index function or an Eigengap heuristic.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

Numerous specific details have been set forth herein to provide a thorough understanding of the embodiments. It will be appreciated, however, that the embodiments may be practiced without these specific details. In other instances, well known operations, components and circuits have not been described in detail so as not to obscure the embodiments. It can be further appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

1. A method for identifying contrasting items to a target item being viewed by a user, the method comprising:
generating, using a co-occurrence module, a co-occurrence score between each item of a plurality of cataloged items against each other item of the plurality of cataloged items, wherein the co-occurrence score between two items is based on one or more documented event actions by one or more users with regards to co-viewing the two items;
generating, using a relevance scoring module, an item relevance score between each item of the plurality of cataloged items against each other item of the plurality of cataloged items, wherein the item relevance score between two items is based on comparisons between text fields associated with the two items;
generating, using a similarity module, similarity scores between each item of the plurality of cataloged items against each other item of the plurality of cataloged items by determining the geometric mean of a product of the co-occurrence scores and the item relevance scores between the items;
identifying, using a contrast selection module, a first item and a second item, the first item having a first similarity score with the target item and the second item having a second similarity score with the target item, the first and second similarity scores being within a threshold of one another; and
causing, using the contrast selection module, simultaneous display of the target item, the first item, and the second item.

2. The method of claim 1, wherein each of the target item, the first item, and the second item are products being offered for sale in an online environment, and the first item has a higher price than the target item and the second item has a lower price than the target item.

3. The method of claim 2, wherein the price of the first item and the price of the second item are within a given price range provided as input by the user.

4. The method of claim 1, comprising
identifying, using the similarity module, one or more features of each of the target item, the first item, and the second item that have a highest influence on a price of each of the items; and
causing, using the contrast selection module, display of the one or more features of each of the target item, the first item, and the second item.

5. The method of claim 4, wherein identifying the one or more features comprises:
performing a regression analysis on prices of at least the target item, first item, and second item using features of the items as inputs to determine a ranking of the features based on their influence on the prices; and
selecting one or more of the top ranked features as the one or more features.

6. The method of claim 1, wherein the one or more event actions comprise one or more of adding the first item and the second item to a cart together, adding the first item and the second item to a wish list together, or ordering the first item and the second item together.

7. The method of claim 1, wherein the text fields of the first item and the second item comprise one or more of item name, item description, item category, item price, or one or more item features.

8. The method of claim 1, wherein generating the item relevance scores comprises using one or more natural language techniques to characterize the text fields, the one or more natural language techniques including at least one of vectorizing, one hot encoding, TFIDF weighting, parsing, stop word removal, speech tagging, sparse data processing, or dense data processing.

9. The method of claim 8, wherein generating the item relevance scores comprises comparing the characterized text fields using a comparison technique that includes at least one of a dot product determination, cosine similarity analysis, L2 analysis, or Hamming distance determination.

10. The method of claim 1, comprising generating, using the similarity module, a similarity matrix of the similarity scores.

11. The method of claim 10, comprising clustering, using the similarity module, the items of the plurality of cataloged items into groups within the similarity matrix based on their similarity scores using a spectral clustering technique, and wherein identifying the first item and the second item comprises identifying the first item and the second item within the same group as the target item.

12. The method of claim 11, wherein the spectral clustering technique comprises a Calinski-Harabasz index function or an Eigengap heuristic.

13. A system configured to identify contrasting items to a target item being viewed by a user, the system comprising:
at least one processor;
a co-occurrence module, executable by the at least one processor, and configured to generate a co-occurrence score between each item of a plurality of cataloged items against each other item of the plurality of cataloged items, wherein the co-occurrence score between two items is based on one or more documented event actions by one or more users with regards to co-viewing the two items;
a relevance scoring module, executable by the at least one processor, and configured to generate an item relevance score between each item of the plurality of cataloged items against each other item of the plurality of cataloged items, wherein the item relevance score between two items is based on comparisons between text fields associated with the two items;
a similarity module, executable by the at least one processor, and configured to generate similarity scores between each item of the plurality of cataloged items against each other item of the plurality of cataloged items by taking a geometric mean of a product of the co-occurrence scores and the item relevance scores between the items; and
a contrast selection module, executable by the at least one processor, and configured to identify a first item and a second item, the first item having a first similarity score with the target item and the second item having a second similarity score with the target item, the first and second similarity scores being within a threshold of one another, and
cause simultaneous display of the target item, the first item, and the second item.

14. The system of claim 13, wherein each of the target item, the first item, and the second item are products being offered for sale in an online environment, and the first item has a higher price than the target item and the second item has a lower price than the target item.

15. A computer program product including one or more non-transitory machine-readable mediums having instructions encoded thereon that when executed by at least one processor cause a process to be carried out for identifying contrasting items to a target item being viewed by a user, the process comprising:
generating a co-occurrence score between each item of a plurality of cataloged items against each other item of the plurality of cataloged items, wherein the co-occurrence score between two items is based on one or more documented event actions by one or more users with regards to co-viewing the two items;
generating an item relevance score between each item of the plurality of cataloged items against each other item of the plurality of cataloged items, wherein the item relevance score between two items is based on comparisons between text fields associated with the two items;
generating similarity scores between each item of the plurality of cataloged items against each other item of the plurality of cataloged items by determining the geometric mean of a product of the co-occurrence scores and the item relevance scores between the items;
identifying a first item and a second item, the first item having a first similarity score with the target item and the second item having a second similarity score with the target item, the first and second similarity scores being within a threshold of one another; and
causing simultaneous display of the target item, the first item, and the second item.

16. The computer program product of claim 15, wherein each of the target item, the first item, and the second item are products being offered for sale in an online environment, and the first item has a higher price than the target item and the second item has a lower price than the target item.

17. The computer program product of claim 15, wherein the process comprises:
identifying one or more features of each of the target item, the first item, and the second item that have a highest influence on a price of each of the items, wherein identifying the one or more features includes performing a regression analysis on prices of at least the target item, first item, and second item using features of the items as inputs to determine a ranking of the features based on their influence on the prices, and selecting one or more of the top ranked features as the one or more features; and
causing display of the one or more features of each of the target item, the first item, and the second item.

18. The computer program product of claim 15, wherein:
the one or more event actions comprise one or more of adding the first item and the second item to a cart together, adding the first item and the second item to a wish list together, or ordering the first item and the second item together;
the text fields of the first item and the second item comprise one or more of item name, item description, item category, item price, or one or more item features.

19. The computer program product of claim 15, wherein generating the item relevance scores comprises: using one or more natural language techniques to characterize the text fields; and comparing the characterized text fields.

20. The computer program product of claim 15, the process comprising:
generating a similarity matrix of the similarity scores; and
clustering the items of the plurality of cataloged items into groups based on their similarity scores using a spectral clustering technique;
wherein identifying the first item and the second item comprises identifying the first item and the second item within the same group as the target item.
